(19) United States
(12) Patent Application Publication
(10) Pub. No.: US 2021/0262535 A1
(43) Pub. Date: Aug. 26, 2021

(54) Apparatus for Controlling a Plurality of Actuators

(71) Applicant: LSP Innovative Automotive Systems GmbH, Unterföhring (DE)

(72) Inventors: Valentin Unterfrauner, Munich (DE); Rainer Winzer, Munich (DE)

(21) Appl. No.: 17/255,322

(22) PCT Filed: Jun. 19, 2019
(86) PCT No.: PCT/EP2019/066166

§ 371 Date: Dec. 22, 2020

(30) Foreign Application Priority Data
Jun. 26, 2018 (DE) 10 2018 115 364.3

(51) Int. Cl. F16D 48/02; F16H 63/34; F16H 61/30; F16H 61/02

(52) U.S. Cl. CPC F16D 48/0206; F16H 63/3483; F16H 61/30; F16H 2061/305; F16D 2500/7109; F16D 2500/3024; F16D 2500/1027; F16H 61/0276

(57) ABSTRACT

The invention relates to an apparatus having a plurality of hydraulic actuators (Sᵢ) and a piston-cylinder unit (K), one working chamber (AK₁) of which is connected, via at least one hydraulic connection line (HL) and supply lines (ZLᵢ), to working chambers (ASᵢ) of the hydraulic actuators (Sᵢ), wherein each working chamber (ASᵢ) of a hydraulic actuator (Sᵢ) is connected to a supply line (ZLᵢ) and switch valves (EVᵢ) for selective opening and closing of the hydraulic supply lines (ZLᵢ) are provided such that, in the opened position of the associated switch valve (EVᵢ), a pressure change in the working chamber (ASᵢ) of the actuator (Sᵢ) or an adjustment of the actuator (Sᵢ) can occur, wherein at least one pressure sensor (DSᵢ) for determining the pressure in a working chamber (ASᵢ) of an actuator (Sᵢ) or a hydraulic line (HL, ZLᵢ, ALᵢ) and a control device (ECU) is provided, characterized in that, for simultaneous pressure change in at least two actuators, (Sᵢ, Sₖ), the (ECU) permanently opens the switch valve (EVᵢ) associated with a first actuator (Sᵢ) during the pressure change phase and adjusts or regulates the pressure by adjusting the piston (KK) of the piston-cylinder unit (K), and in that the control device (ECU) adjusts or regulates the pressure in at least one additional actuator (Sₖ) by means of the switch valve (EVₖ), which is clocked during the pressure change phase, and in particular is controlled by pulse width modulation.

### TECHNICAL FIELD

The present invention relates to an apparatus comprising a plurality of hydraulic actuators and a piston-cylinder unit, a working chamber of which is connected, via at least one hydraulic connection line and supply lines, to working chambers of the hydraulic actuators, wherein each working chamber of a hydraulic actuating unit is connected to a supply line, and switch valves are provided for selectively opening and closing the hydraulic supply lines such that, in the open position of the associated switch valve, a pressure change in the working chamber of the actuator or a movement of the actuator can take place, wherein at least one pressure sensor is provided for determining the pressure in a working chamber of an actuator or a hydraulic line, and a control device is provided.

Apparatuses for moving clutches and gear selectors are known for example from DE 10 2006 038 446 A1, WO 2016/146692 A1 and WO 2018/046145 A1.

In the apparatus known from DE 10 2006 038 446 A1, up to six actuators in the form of two clutches and four gear selectors are moved by means of a piston-cylinder unit having a single-stroke piston. Said apparatus is designed in such a way that simultaneously the pressure in one actuator can be built up and the pressure in another actuator can be reduced.

The apparatuses known from WO 2016/146692 A1 and WO 2018/046145 A1 comprise piston-cylinder units having double-stroke pistons, which in each case sealingly separate two working chambers from each other. In all the aforementioned apparatuses, the pressure in one actuator is built up in that the associated switch valve, which functions as an inlet valve during the pressure build-up phase, is continuously open and the pressure is adjusted by way of the piston movement.

The problem addressed by the present invention is that of further developing the aforementioned systems and of providing a flexible and simple apparatus in which it is possible to change the pressure in at least two actuators to different pressure levels simultaneously.

This problem is solved according to the invention by an apparatus having the features of claim 1. Advantageous further developments of the apparatus according to claim 1 will become apparent from the features of the dependent claims.

The apparatus according to the invention according to claim 1 is characterized in that, in order to change the pressure in at least two actuators simultaneously, the control unit continuously opens the switch valve belonging to a first actuator during the pressure change phase and sets or adjusts the pressure by way of the movement of the piston of the piston-cylinder unit, and in that the control device sets or adjusts the pressure in at least one further actuator by means of the associated switch valve, which is clocked during the pressure change phase and in particular is controlled by means of pulse width modulation. The switch valves must therefore be able to be switched sufficiently rapidly, and the power output stages for the valves must be dimensioned accordingly.

The pressure in the first and/or further actuator can in this case be set using at least one pressure sensor, wherein said at least one sensor determines the pressure in a hydraulic line and/or the working chamber of the respective actuator. It is also possible that the pressure in the first actuator, in which the pressure is changed by way of the piston movement while at the same time the switch valve is continuously open, is set using the motor current and/or the rotor position or the rotor angle of the drive of the piston-cylinder unit and/or the pressure-volume characteristic of the apparatus.

If just one single switch valve is assigned to each actuator, only a joint pressure build-up or pressure reduction in a plurality of actuators can take place. A pressure build-up in one actuator and a simultaneous pressure reduction in another actuator is not possible with such an apparatus. However, if at least one or each actuator is assigned an additional outlet valve, which is arranged in a hydraulic drain line, the hydraulic medium can flow out of the working chamber of the actuator towards a reservoir, and a simultaneous pressure build-up and pressure reduction in two or more actuators is possible. The outlet valves may in this case be clocked, as a result of which a controlled pressure reduction in the respective actuator is possible. To this end, the pressure in the discharge line or in the working chamber of the actuator can be determined by means of a pressure sensor for pressure control and appropriate clocking of the outlet valve.

In another advantageous development, a common outlet valve which can be rapidly clocked and which is designed in particular for pulse width modulation may be provided in a common drain line in order to selectively open and close the common drain line, and also a common pressure transducer may be provided. As a result, it is possible to reduce only the number of required pressure transducers and to keep the individual outlet valves simple and small since these need only be designed for relatively low switching frequencies. Only the common clockable outlet valve and the power output stage thereof must be designed for high switching frequencies. A not inconsiderable cost advantage is achieved as a result.

The actuators of the apparatus according to the invention may in each case have a piston-cylinder unit with a working chamber and a movable piston, wherein either the clutch, the gear selector or the multi-plate clutch thereof can be moved by way of the piston. The apparatus may thus be, for example, a powershiftable 2-speed transmission with or without torque vectoring. The apparatus according to the invention may also advantageously have at least one actuator which is a hydraulic parking lock or parking brake or a hydraulically switchable freewheel, or a hydraulically actuated brake.

In addition, the piston of the piston-cylinder unit may advantageously be a single-stroke piston which delimits only a single working chamber, resulting in a simple and inexpensive design of the piston-cylinder unit.

Several possible embodiments of the invention will be explained below with reference to drawings.

### BRIEF DESCRIPTION OF DRAWINGS

FIG. 1: shows a first possible embodiment of an apparatus according to the invention in the form of a powershiftable 2-speed transmission;

FIG. 1a: shows an apparatus for building up or reducing the pressure in three actuators simultaneously;

FIG. 2: shows an apparatus according to the invention in the form of a powershiftable 2-speed transmission;

FIG. 2a: shows an apparatus for building up and/or reducing the pressure in three actuators simultaneously, the figure showing the pressure being built up in two actuators simultaneously, the pressure being built up in one actuator by way of the piston movement and in the other actuator by way of the clocking of the switch valve;

FIG. 2b: shows an apparatus according to FIG. 2a, the figure showing the pressure being reduced in two actuators simultaneously, the pressure being reduced in one actuator by way of the piston movement and in the other actuator by way of the clocking of the outlet valve;

FIG. 3: shows an apparatus according to the invention with five actuators;

FIG. 4a: shows another possible embodiment, wherein the apparatus has a common outlet valve arranged in the drain line, said common outlet valve being designed for rapid clocking such that, when the outlet valve of an actuator is continuously open during the pressure reduction phase, the pressure in said actuator can be reduced by way of the clocking of the common outlet valve, each actuator being assigned a pressure sensor;

FIG. 4b: shows an embodiment with a common pressure sensor which serves to determine the pressure in the common drain line, and with an optional pressure sensor which serves to determine the pressure in the hydraulic line that connects the working chamber of the piston-cylinder system to the actuators;

FIG. 5: shows an apparatus according to FIG. 4 with three instead of two actuators;

FIG. 6: shows an apparatus according to FIG. 4 with five instead of two actuators.

### DETAILED DESCRIPTION

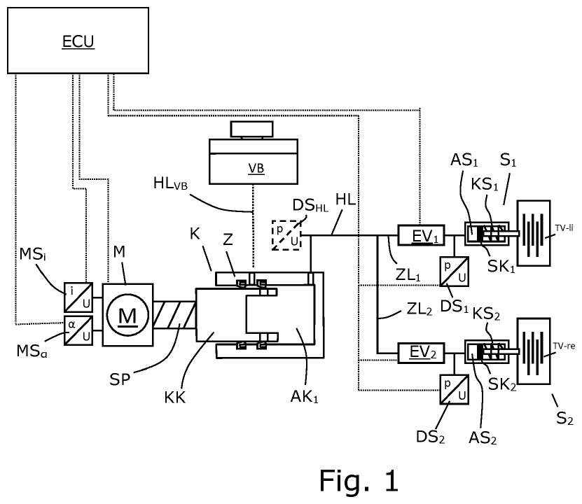

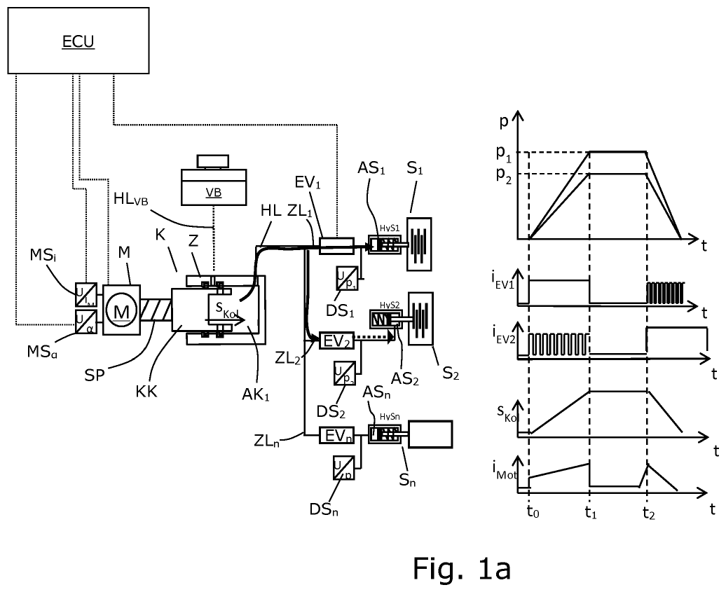

FIG. 1 shows an apparatus according to the invention in the form of a powershiftable 2-speed transmission. The 2-speed transmission has a piston-cylinder unit K and two actuators S₁ and S₂. The piston-cylinder unit K has a cylinder Z and a piston KK displaceably mounted therein, which piston is driven by a motor drive M via a spindle SP. Sensors MSᵢ and/or MS_{α} may be provided for measuring the motor current and the motor angle. The piston KK and the cylinder Z delimit a working chamber AK₁, which is connected to a hydraulic connection line HL. The hydraulic connection line HL is connected to supply lines ZL₁ and ZL₂. The supply lines ZL₁ and ZL₂ are respectively connected to working chambers AS₁ and AS₂ of the piston-cylinder systems KS₁ and KS₂, wherein a switch valve EV₁ is arranged in the supply line ZL₁ and a switch valve EV₂ is arranged in the supply line ZL₂ in order to selectively open and close the respective supply line. Between the switch valve EV₁ and the working chamber AS₁, the pressure can be determined by means of a first pressure sensor DS₁. Between the switch valve EV₂ and the working chamber AS₂, the pressure can be determined by means of a second pressure sensor DS₂. The pistons SK₁ and SK₂ displaceably mounted in the piston system KS₁ and KS₂ move the clutches TV-LI and TV-RE via a tappet. If there is no pressure or insufficient pressure in the working chambers AS₁ and AS₂, the clutches TV-LI and TV-RE are open. Optionally, the pressure in the hydraulic line HL can be determined using a pressure sensor DS_{HL}. The control unit ECU, which is connected to the drive M, to the switch valves EV₁ and EV₂ and also to the pressure sensors DS₁ and DS₂ and optionally to the pressure sensor DS_{HL} via the signal and/or communication lines shown in dashed line, controls the 2-speed transmission. The working chamber AK₁ of the piston-cylinder unit K is connected to a reservoir VB via the hydraulic connection line HL_{VB}.

According to the invention, it is possible to change the pressure for example in the working chamber AS₁ of the actuator S₁, in which the associated switch valve EV₁ is continuously open during the pressure change phase, wherein the pressure in the working chamber AS₁ is set by way of the piston movement of the piston KK. For example, the pressure in the supply line ZL₁ may be continuously determined by means of the sensor DS₁ and adjusted by way of the piston movement of the piston KK. The pressure-volume characteristic can also be used or taken into account in the control.

The switch valves EV₁ and EV₂ are designed such that they can be switched at a sufficiently high switching frequency, for example by means of pulse width modulation PWM. The pressure in the second actuator S₂ can thus be changed simultaneously by clocking the switch valve EV₂. In this case, it is advantageous if a pressure control takes place by measuring the pressure in the supply line ZL₂ by means of the sensor DS₂.

In the apparatus shown in FIG. 1, the pressure in both working chambers AS₁ and AS₂ can only be simultaneously built up or reduced. With this apparatus, it is not possible to reduce the pressure in one actuator and to build up the pressure in the other actuator simultaneously. Of course, it is also possible that the pressure in the actuators is changed successively, wherein then in each case the associated switch valve EVᵢ is open and the pressure in the actuator is adjusted by the movement of the piston KK.

FIG. 1a shows an apparatus for building up or reducing the pressure in three actuators simultaneously. Said apparatus is basically constructed in a manner identical to the apparatus in FIG. 1, but also has an additional supply line ZLₙ, via which a further actuator Sₙ is connected to the hydraulic connection line HL. A switch valve EVₙ is also provided in the supply line ZLₙ in order to selectively open and close the supply line ZLₙ. In principle, any number of further actuators Sₙ can be provided in a corresponding manner. FIG. 1a shows the simultaneous pressure build-up and subsequent simultaneous pressure reduction in the actuators S₁ and S₂, which starts at the time t₀. By means of the piston-cylinder unit K, by moving the piston KK, which is moved to the right along the piston path S_{Kol}, there is built up in the hydraulic line HL a pressure p₁ which corresponds to the pressure that is to be built up in the working chamber AS₁ of the actuator S₁. By means of the current i_{EV1}, a current flows continuously through the switch valve EV₁ during the pressure build-up phase, which lasts from t₀ to t₁, and thus said switch valve is continuously open, so that the pressure acting in the hydraulic line HL acts in the working chamber AS₁. The pressure in the hydraulic line HL is also applied to the input of the switch valve EV₂. By clocked switching of the switch valve EV₂ by means of the current i_{EV2}, liquid also flows into the working chamber AL₂ of the second actuator S₂, as illustrated by the dashed arrow, so that a pressure p₂, which is lower than the pressure p₁, is also set therein.

At the time t₁, the required pressure p₁ and respectively p₂ is reached in both actuators S₁ and S₂, and therefore the switch valves EV₁ and EV₂ are closed at the time t₁, as a result of which the pressure in the working chambers AS₁ and AS₂ is maintained and the clutches of the actuators S₁ and S₂ remain in their position. The pressure reduction starts at the time t₂, wherein the switch valve EV₁ is clocked by means of the current i_{EV1} and the switch valve EV₂ is continuously open by means of the current I_{EV2} until the pressure in the respective working chambers AS₁ and AS₂ has been completely reduced by moving the piston KK to the left. As shown in FIG. 1, the pressure in the actuator Sₙ is not changed during the pressure build-up and pressure reduction phase in the actuators S₁ and S₂. However, it is also possible that, simultaneously with the pressure change in the actuators S₁ and S₂, a pressure change also takes place in the actuator Sₙ by switching the switch valve EVₙ.

In principle, in order to change the pressure in a plurality of actuators Sᵢ, Sₖ simultaneously, in a first actuator Sᵢ the pressure takes place to a first pressure level p₁ by moving the piston KK of the piston-cylinder unit K while at the same time the associated switch valve EVᵢ is continuously open, and in at least one further actuator Sₖ the pressure change takes place to a further pressure level p₂, wherein the switch valve EVₖ belonging to the actuator Sₖ is clocked or is operated for example by means of pulse width modulation. The pressure p₁ is greater than the pressure p₂ in the case of a pressure build-up and is lower than the pressure p₂ in the case of a pressure reduction.

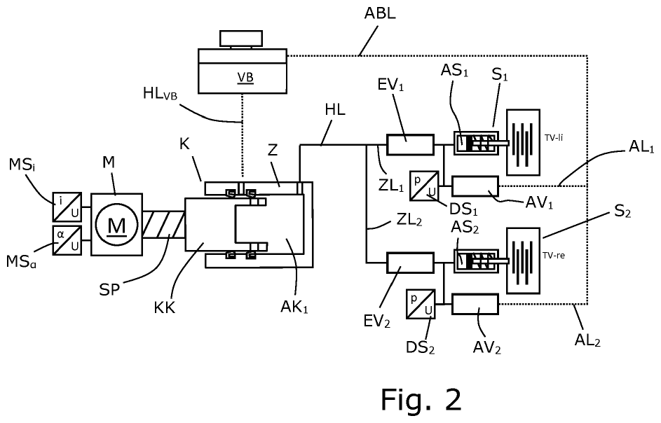

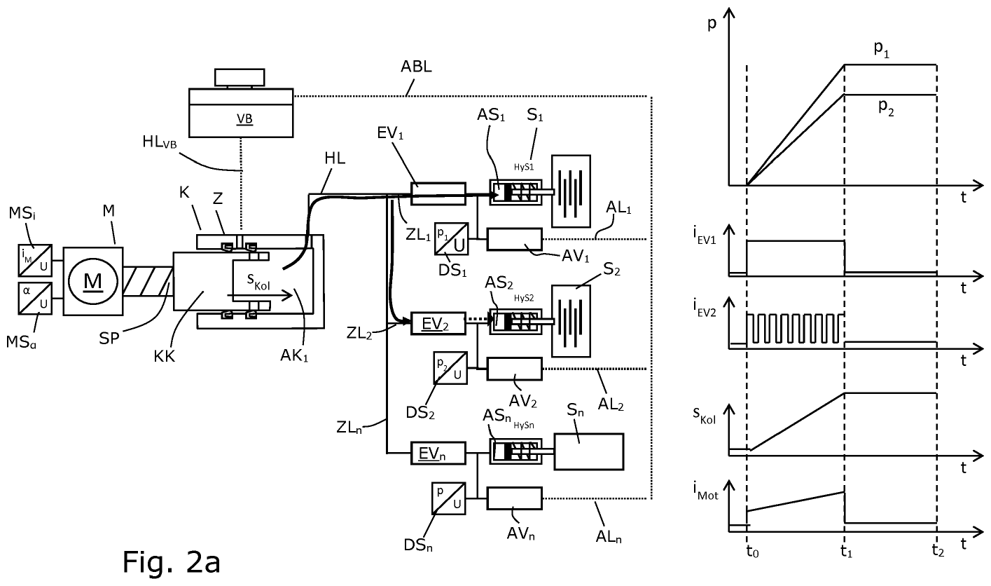

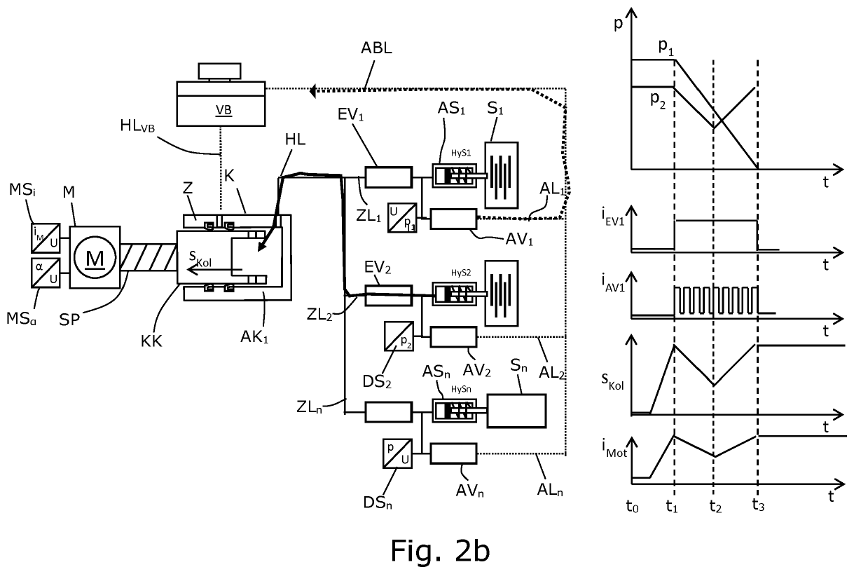

FIG. 2 shows an apparatus according to the invention as a powershiftable 2-speed transmission, wherein, in addition to the switch valves EV₁ and EV₂ arranged in the supply lines ZL₁ and ZL₂, outlet valves AV₁ and AV₂ are also provided, by means of which the drain lines AL₁ and AL₂ can selectively be shut off so that hydraulic fluid can flow via the drain line AL₁ or AL₂, when the outlet valve AV₁ or AV₂ is open, towards the common drain line ABL and towards the reservoir VB. By clocking and simultaneously measuring the pressure in the respective working chamber AS₁ or AS₂ or in the drain line AL₁ or AL₂ by means of the pressure sensors DS₁ or DS₂, the pressure in the respective working chamber AS₁ or AS₂ can be reduced in a controlled manner towards the reservoir VB.

FIG. 2a shows the apparatus according to FIG. 2 which has been expanded by a further actuator Sₙ, wherein yet more actuators (not shown) may be provided which can likewise be connected, via a supply line ZLₙ, to the hydraulic line HL or directly to the working chamber AK₁. FIG. 2a shows the simultaneous pressure build-up, which takes place in a manner identical to the pressure build-up shown and explained in FIG. 1a, that is to say the pressure p₁ is generated by moving the piston KK of the piston-cylinder unit K, wherein, during the pressure build-up phase between t₀ and t₁, a current continuously flows through the switch valve EV₁ and thus said switch valve is open, and the switch valve is rapidly clocked. The pressure generated by means of the piston-cylinder unit K and the duty cycle between the opening and closing of the switch valve EV₂ determines the rate of pressure change in the working chamber AS₂. At t₁, the required pressure has been set both in the working chamber AS₁ and in the working chamber AS₂. In addition, the actuators Sᵢ also have additional outlet valves AVᵢ, by way of which the pressure in the respective actuator Sᵢ can be reduced.

FIG. 2b shows an apparatus according to FIG. 2a, wherein, in the apparatus shown in FIG. 2b, the pressure is reduced in two actuators S₁ and S₂ simultaneously between the times t₁ and t₂, and from the time t₂ the pressure in the actuator S₁ continues to reduce until the time t₃, at which there is zero pressure, and the pressure in the actuator S₂ at the time t₃ has been increased back to the initial pressure p₂ by way of the piston movement s_{Kol}.

Either one pressure sensor DSᵢ or all pressure sensors DS₁₋₃ can be used to control the drive M and/or the clocked valve(s) EVᵢ and/or ALᵢ. However, it is also possible to determine or estimate the pressure in the working chamber ASᵢ of the piston-cylinder unit K by way of the pressure-volume characteristic, the motor current i and the piston position of the piston-cylinder unit K.

Here, too, the pressure reduction in the actuator S₂ takes place by way of the piston movement s_{Kol} while at the same time the switch valve EV₂ is continuously open. The pressure reduction in the actuator S₁ takes place by way of the clocked outlet valve AV₁, wherein the pressure in the working chamber AS₁ is continuously determined by means of the pressure sensor DS₁ and is taken into account in controlling the pressure reduction in the actuator S₁.

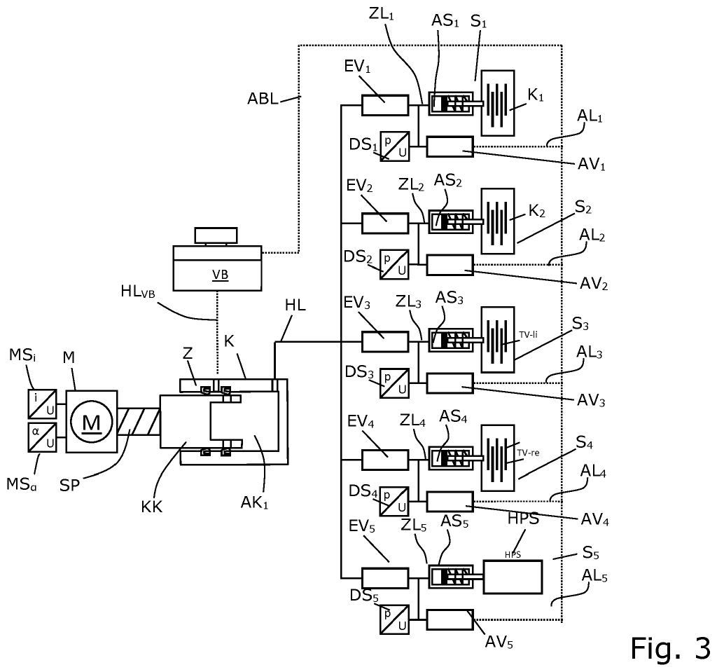

FIG. 3 shows an apparatus according to the invention with five actuators in the form of a 2-speed transmission with torque vectoring. Here, the actuator S₁ is a first clutch K₁, the second actuator S₂ is a second clutch K₂, the actuators S₃ and S₄ are the multi-plate clutches TV-li and TV-re, and the actuator S₅ is a hydraulically actuated parking lock HPS.

The pressure build-up and pressure reduction in the individual actuators S₁₋₅ can take place in a manner analogous to the embodiments described above.

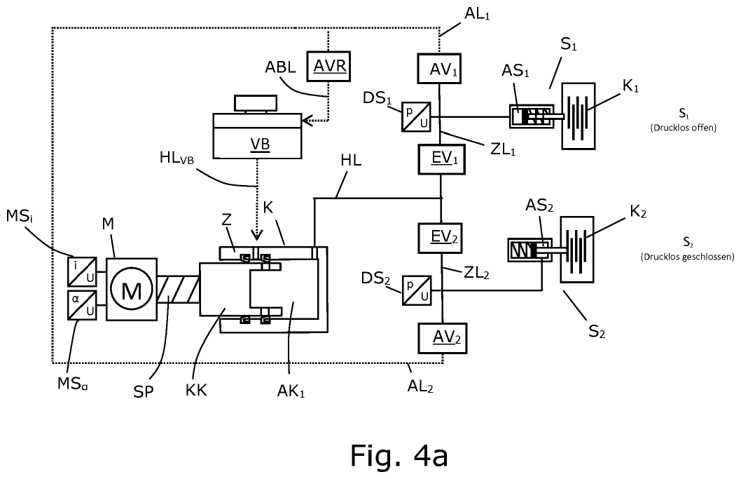

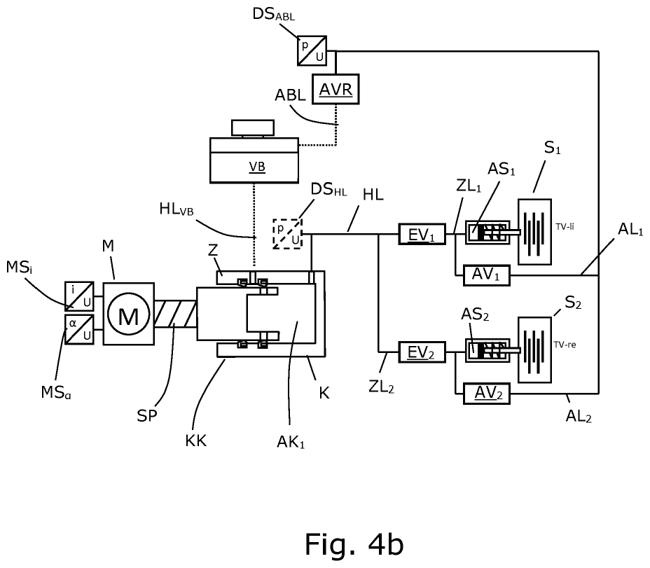

FIG. 4a shows another possible embodiment of the apparatus according to the invention, wherein the apparatus has a common outlet valve AVR arranged in the common drain line ABL, said common outlet valve being designed for rapid clocking. To reduce the pressure in one actuator Sᵢ, the outlet valve AVᵢ associated with the respective actuator Sᵢ is continuously open during the pressure reduction phase. The actual pressure control takes place by way of the clocking of the common outlet valve AVR. Each actuator may be assigned a pressure sensor DS₁ and DS₂. However, it is also possible that, as shown in FIG. 4b, the pressure in the respective actuator Sᵢ can be determined by way of a common pressure sensor DS_{ABL} since the outlet valve AVᵢ is continuously open during the pressure reduction. In addition, a further pressure sensor DS_{HL} may be provided, the signals of which can likewise be used to control the pressure in the actuators Sᵢ. The pressure sensor DS_{HL} may be omitted for example if the pressure in the working chamber AK₁ of the piston-cylinder unit K can be precisely calculated by way of a motor current measurement MSᵢ and/or a rotor angle measurement MS_{α}. Optionally, the pressure-volume characteristic(s) of the apparatus can also be used for pressure control.

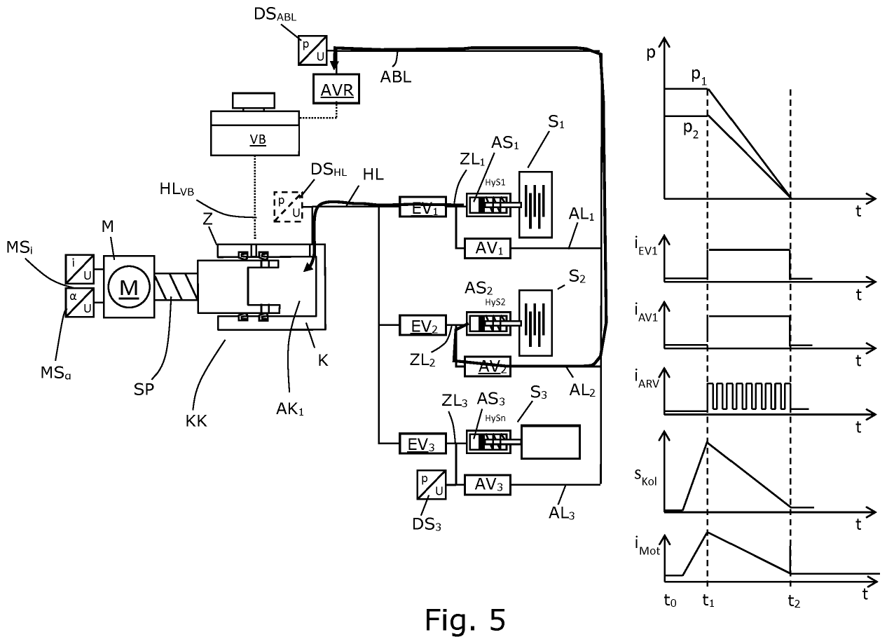

FIG. 5 shows the apparatus according to FIG. 4 with three instead of two actuators S₁₋₃, wherein the pressure reduction in the actuator S₂ takes place by way of the clocked common switch valve AVR, wherein the pressure in the common drain line ABL is continuously determined by means of the pressure sensor DS_{ABL} and is taken into account in controlling the switch valve AVR. Between the times t₁ and t₂, the pressure in the actuator S₁ is reduced from an initial pressure p₁ to zero pressure and the pressure in the actuator S₂ is reduced from an initial pressure p₂ to zero pressure. Both the switch valve EV₁ and the outlet valve AV₂ are continuously open between the times t₁ and t₂. The pressure reduction in the actuator S₁ takes place by way of the piston movement of the piston-cylinder unit K.

The switch valve AVR must be designed for sufficiently high switching frequencies, wherein the control stage for the switch valve AVR must also be dimensioned for the high switching frequencies. In contrast, the outlet valves AVi can be simple, inexpensive switch valves.

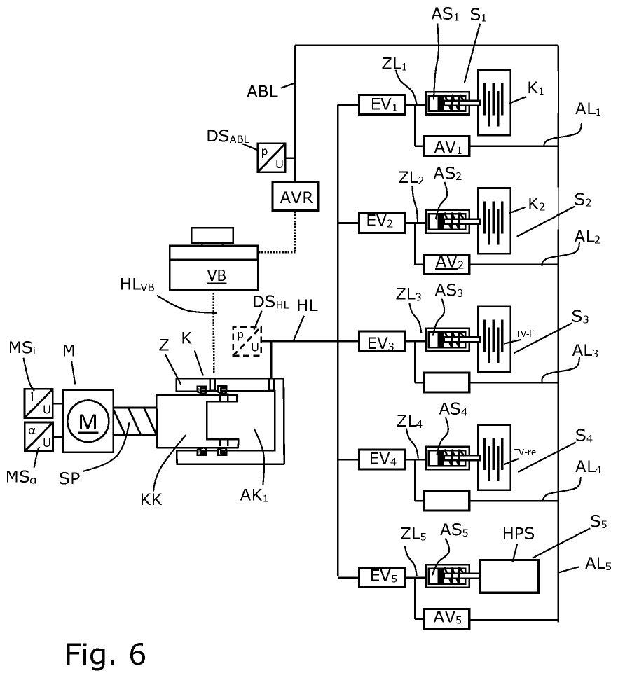

FIG. 6 shows an apparatus according to FIG. 4 with five instead of two actuators, in the form of a 2-speed gearbox with torque vectoring, wherein the pressure build-up and/or pressure reduction in the individual actuators S₁₋₅ takes place in a manner analogous to the apparatuses described above.

1. Apparatus comprising a plurality of hydraulic actuators (Sᵢ) and a piston-cylinder unit (K), which comprises a working chamber (AK₁) which is connected, via at least one hydraulic connection line (HL) and supply lines (ZLᵢ), to working chambers (ASᵢ) of the hydraulic actuators (Sᵢ), wherein each working chamber (ASᵢ) of a hydraulic actuating unit (Sᵢ) is connected to a supply line (ZLᵢ), and switch valves (EVᵢ) are provided for selectively opening and closing the hydraulic supply lines (ZLᵢ) such that, in the open position of the associated switch valve (EVᵢ), a pressure change in the working chamber (ASᵢ) of the actuator (Sᵢ) or a movement of the actuator (Sᵢ) can take place, wherein at least one pressure sensor (DSᵢ) is provided for determining the pressure in a working chamber (ASᵢ) of an actuator (Sᵢ) or a hydraulic line (HL, ZLᵢ, ALᵢ), and a control device (ECU) is provided, characterized in that, in order to change the pressure in at least two actuators (Sᵢ, Sₖ) simultaneously, the control device (ECU) continuously opens the switch valve (EVᵢ) belonging to a first actuator (Sᵢ) during the pressure change phase and sets or adjusts the pressure by way of the movement of the piston (KK) of the piston-cylinder unit (K), and in that the control device (ECU) sets or adjusts the pressure in at least one further actuator (Sₖ) by means of the switch valve (EVₖ), which is clocked during the pressure change phase, and that the apparatus is a 2-speed transmission with torque vectoring.

2. Apparatus according to claim 1, characterized in that the pressure in the first and/or further actuator (Sᵢ, Sₖ) is set using at least one pressure sensor (DSᵢ, DSₖ), by which the pressure in a hydraulic line (HL, ZLᵢ, ZLₖ, ALᵢ, ALₖ, ABL) and/or in the working chamber (ASᵢ, ASₖ) of the respective actuator (Sᵢ, Sₖ) can be determined.

3. Apparatus according to claim 1, characterized in that the pressure in the first actuator (Sᵢ) is set using the motor current and/or the rotor position or the rotor angle (α) of the drive (M) of the piston-cylinder unit (K).

4. Apparatus according to claim 1, characterized in that at least one or each actuator (Sᵢ) is assigned an outlet valve (AVᵢ) which is arranged in a hydraulic drain line (ALᵢ), via which hydraulic medium can flow out of the working chamber (ASᵢ) of the actuator (Sᵢ) towards a reservoir (VB).

5. Apparatus according to claim 4, characterized in that a common outlet valve (AVR) designed for pulse width modulation is arranged in a common drain line (ABL) in order to selectively open and close the common drain line (ABL).

6. Apparatus according to claim 5, characterized in that the outlet valves (AVᵢ) and the power output stages thereof are designed for switching frequencies which are smaller than the switching frequencies of the common outlet valve (AVR), wherein, in order to reduce the pressure in an actuator (Sᵢ), the outlet valve (AVᵢ) assigned thereto is continuously open during the pressure reduction phase and the controlled or regulated pressure reduction in the actuator (Sᵢ) takes place by way of the clocking of the common outlet valve (AVR).

7. Apparatus according to claim 1, characterized in that the pressure in the hydraulic medium can be determined by means of a pressure sensor (DSA) in the common drain line (ABL) or in a drain line (ALᵢ) between the outlet valve (AVᵢ) and the reservoir (VB).

8. Apparatus according to claim 1, characterized in that each actuator (Sᵢ) is assigned a pressure sensor (DSᵢ), by means of which the pressure in the actuator (Sᵢ) can be determined.

9. Apparatus according to claim 1, characterized in that each actuator (Sᵢ) has a piston-cylinder unit (KSᵢ) comprising the working chamber (ASᵢ) and a movable piston (SKᵢ), wherein either the clutch (Kᵢ), the gear selector or the multi-plate clutch (TV-li, TV-re) thereof can be moved by way of the piston (SKᵢ).

10. Apparatus according to claim 9, characterized in that at least two actuators (Sᵢ) move clutches (Kᵢ) of a transmission of a vehicle.

11. Apparatus according to claim 9, characterized in that at least one actuator (Sᵢ) is a gear selector.

12. Apparatus according to claim 1, characterized in that at least one actuator (Sᵢ) is a hydraulic parking lock or parking brake, a hydraulically actuated freewheel, or a hydraulically actuated brake.

13. (canceled)

14. Apparatus according to claim 1, characterized in that the piston (KK) of the piston-cylinder unit (K) is a single-stroke piston which delimits only a single working chamber (AK₁).

15. Method for changing the pressure in an apparatus having a plurality of hydraulic actuators (Sᵢ) and a piston-cylinder unit (K), which comprises a working chamber (AK₁) which is connected, via at least one hydraulic connection line (HL) and supply lines (ZLᵢ), to working chambers (ASᵢ) of the hydraulic actuators (Sᵢ), characterized in that, in order to change the pressure in a plurality of actuators (Sᵢ, Sₖ) simultaneously, in a first actuator (Sᵢ) the pressure takes place to a first pressure level (p₁) by way of the movement of the piston (KK) of the piston-cylinder unit (K) while at the same time the associated switch valve (EVᵢ) is continuously open, and in that in at least one further actuator (Sₖ) the pressure change takes place to a further pressure level (p₂) by opening and/or clocking the associated outlet valve (AVₖ), wherein, by changing the pressure, a gear change is effected in a 2-speed transmission with or without torque vectoring.

16. Method according to claim 15, characterized in that, when building up the pressure in at least two actuators (Sᵢ, Sₖ, Sₘ) simultaneously, the first pressure level (p₁) to be set or adjusted in the first actuator (Sᵢ) is greater than the further pressure level(s) (p₂, p_{2′}) of the at least one further actuator (Sₖ, Sₘ).

17. Method according to claim 15, characterized in that a pressure build-up or pressure reduction in at least one actuator (Sᵢ) takes place by means of the piston-cylinder unit (K), wherein a pressure reduction in at least one actuator (Sₖ) takes place by way of at least one outlet valve (AVᵢ), wherein the pressure reduction takes place either
by clocking the outlet valve(s) (AVᵢ),
or
by way of an outlet valve (AVᵢ) which is continuously open during the pressure reduction phase, wherein the common outlet valve (AVR) is clocked or is operated by means of pulse width modulation.

18. Method for changing the pressure in an apparatus having a plurality of hydraulic actuators (Sᵢ) and a piston-cylinder unit (K), which comprises a working chamber (AK₁) which is connected, via at least one hydraulic connection line (HL) and supply lines (ZLᵢ), to working chambers (ASᵢ) of the hydraulic actuators (Sᵢ), wherein a respective switch valve (EVᵢ) is arranged between the piston-cylinder unit (K) and each hydraulic actuator (Sᵢ), the method comprising the following steps:
building up the pressure and/or reducing the pressure in the plurality of hydraulic actuators (Sᵢ) simultaneously,
moving the piston while simultaneously opening or PWM-clocking the switch valves (EVᵢ) in order to build up the pressure, and
simultaneously actuating a plurality of hydraulic actuators (Sᵢ) by way of the build-up of pressure, wherein at least one hydraulic actuator (Sᵢ) is a hydraulic parking lock or parking brake, a hydraulically actuated freewheel, a hydraulically actuated brake, or a 2-speed transmission with or without torque vectoring.

19. Method according to claim 18, characterized in that, when building up the pressure in at least two actuators (Sᵢ, Sₖ, Sₘ) simultaneously, the first pressure level (p₁) to be set or adjusted in the first actuator (Sᵢ) is greater than the further pressure level(s) (p₂, p_{2′}) of the at least one further actuator (Sₖ, Sₘ).

20. Method according to claim 18, characterized in that a pressure build-up or pressure reduction in at least one actuator (Sᵢ) takes place by means of the piston-cylinder unit (K), wherein a pressure reduction in at least one actuator (Sₖ) takes place by way of at least one outlet valve (AVᵢ), wherein the pressure reduction takes place either
by clocking the outlet valve(s) (AVᵢ),
or
by way of an outlet valve (AVᵢ) which is continuously open during the pressure reduction phase, wherein the common outlet valve (AVR) is clocked or is operated by means of pulse width modulation.
